(19) United States
(12) Patent Application Publication
(10) Pub. No.: US 2007/0299810 A1
(43) Pub. Date: Dec. 27, 2007

(54) AUTONOMIC APPLICATION TUNING OF DATABASE SCHEMA

(76) Inventors: Philip Ronald Riedel, Cary, NC (US); David G. Robinson, Cary, NC (US); Shaw-Ben Shepherd Shi, Austin, TX (US)

Correspondence Address: IBM CORP (YA);C/O YEE & ASSOCIATES PC, P.O. BOX 802333, DALLAS, TX, 75380, US

(21) Appl. No.: 11/426,190

(22) Filed: Jun. 23, 2006

(51) Int. Cl. G06F 17/30

(52) U.S. Cl. 707/2

(57) ABSTRACT

A computer implemented method, apparatus, and computer usable program code for managing a database. Performance data is determined for the database. The performance data relies on a key of the database. A schema of the database is autonomically modified by making changes utilizing the performance data in response to determining the performance data.

### BACKGROUND

1. Technical Field

The present invention relates generally to an improved data processing system. More particularly, the present invention relates to a computer-implemented method, apparatus, and computer program product for managing and tuning performance of a database.

2. Description of the Related Art

Increasing numbers of companies and individuals rely on database products to access large amounts of data efficiently. The data is often stored in a relational database. A relational database is a database system in which the database is organized and accessed according to the relationships between data items without the need for any consideration of physical orientation and relationships. Relationships between data items in a relational database are expressed by means of a collection of tables logically associated to each other by shared attributes or keys. Any data element may be found in a relational database using the name of the table, the attribute (column) name, and the value of the primary key.

Relational database product providers recognize the need to reduce the manual intensiveness of maintaining relational database applications. In order to save time and effort, efforts have been made to create “intelligent” relational database software in order to reduce the amount of manual tuning required to maintain good performance.

Conventional database solutions focus on improving the database engine rather than the database application. For example, query optimizer technology in the database may be used to create self-tuning histograms. Attempts have also been made using a learning optimizer to learn from past experiences when accessing the relational database which on rewriting or redirecting queries for optimal execution based on the data and self-tuning databases through the auto-creation of views, materialized views, and indexes. A query is a request or a specific set of instructions for extracting particular data from a database. Queries are made up of data items or fields to be retrieved and may have limits set on the scope of the data and/or sorting order specified.

Each of the different previously-described approaches require users or administrators to manually update application software to implement algorithms necessary to match tuning done in the database. Accordingly, no conventional systems adequately provide application programs that can automatically self-tune a relational database for performance.

### BRIEF SUMMARY

The illustrative embodiments described herein provide a computer-implemented method, apparatus, and computer usable program code for managing a database. In one embodiment, performance data is determined for a database. The performance data relies on a key of the database. A schema of the database is autonomically modified by making changes utilizing the performance data in response to determining the performance data.

### BRIEF DESCRIPTION OF THE DRAWINGS

The novel features believed characteristic of the illustrative embodiments are set forth in the appended claims. The illustrative embodiments, themselves, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a data processing system in which illustrative embodiments of the present invention may be implemented;

FIG. 2 is a block diagram of a data processing system in which illustrative embodiments of the present invention may be implemented;

FIG. 3 is a block diagram of a database system in accordance with an illustrative embodiment of the present invention;

FIG. 4A is a table structure before autonomic tuning in accordance with an illustrative embodiment of the present invention;

FIG. 4B is a database structure after autonomic tuning in accordance with an illustrative embodiment of the present invention;

FIG. 4C is a more detailed table structure illustrating autonomic tuning in accordance with an illustrative embodiment of the present invention;

FIG. 5 is an exemplary policy file in accordance with an illustrative embodiment of the present invention;

FIG. 6 is an exemplary table monitor application program interface set in accordance with an illustrative embodiment of the present invention;

FIG. 7 is a flowchart of an application process using a table monitor in accordance with an illustrative embodiment of the present invention;

FIG. 8 is a flowchart of a tuning thread process in a table monitor in accordance with an illustrative embodiment of the present invention;

FIG. 9 is a flowchart of a main thread initialization process in a table monitor in accordance with an illustrative embodiment of the present invention; and

FIG. 10 is a flowchart of a scan thread flow in a table monitor in accordance with an illustrative embodiment of the present invention.

### DETAILED DESCRIPTION OF AN ILLUSTRATIVE EMBODIMENT

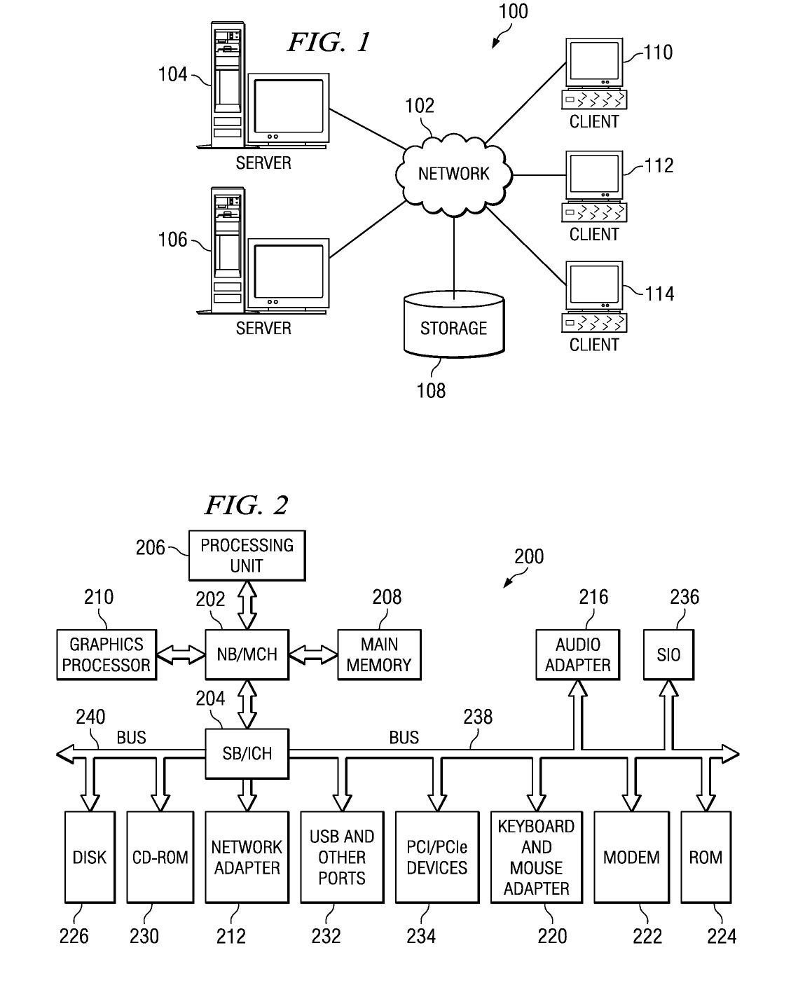

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which one or more embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing processes or methods as described herein may be located for illustrative embodiments of the present invention.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

In the illustrated embodiment of FIG. 2, an operating system runs on processor 206 and coordinates and provides control of various components within data processing system 200. The operating system may be a commercially available operating system such as Microsoft® Windows® XP (Microsoft and Windows are trademarks of Microsoft Corporation in the United States, other countries, or both). An object oriented programming system, such as the Java programming system, may run in conjunction with the operating system and provide calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and computer usable program code for autonomic tuning of a database at the database application level. Autonomic tuning indicates that a table monitor and corresponding application self-manages tables without the necessity of user intervention or the use of relational database engine tools. A database application is used to perform autonomic tuning of the database for its own enhanced performance. A table monitor within the database application monitors performance data and analyzes data skew in database tables. In these examples, the table monitor is a data layer monitor embedded in the database application. Performance data indicates how well the database application is performing in accessing and updating data. For example, performance data may indicate access attributes or keys such as minimum, maximum, and average access times for each table in the database based on prior access of the database. Data skew is the uneven distribution of data values in a database table such that one particular value or values becomes significantly more abundant in the table than others. This is particularly significant for columns that represent the keys to the database table.

The table monitor applies application-specific knowledge unavailable to conventional database optimizers. The type or semantic meaning of data contained in each database table and how that data is used within the application is only known by the application and not the relational database engine. Application-specific knowledge includes, in one embodiment, data specifying the type of queries issued against a particular table or set of data and how the returned information is used inside the application.

Based on a policy defined for the application and application-specific knowledge of how tables in the schema are used, the table monitor takes autonomic action to tune or alter the database schema and queries used by the application. The schema is a description of the data represented within a database. For example, the schema may specify a format for phone numbers, addresses, or number configurations for social security numbers or other table attributes or keys including primary keys and secondary keys. The format of the description varies but includes a table layout for a relational database.

Autonomic action is taken by the database application in response to negative performance data. Specifically, the table monitor component in the database application takes action when either query performance becomes too slow, as determined by policy file settings or data skew in the monitored table(s) becomes pronounced. Specific autonomic actions taken by the database application, via the table monitor include:
(a). automatically generating relational database statistics on certain tables;
(b). creating new tables and/or views in the database;
(c). altering database query definitions based on the altered tables/views.

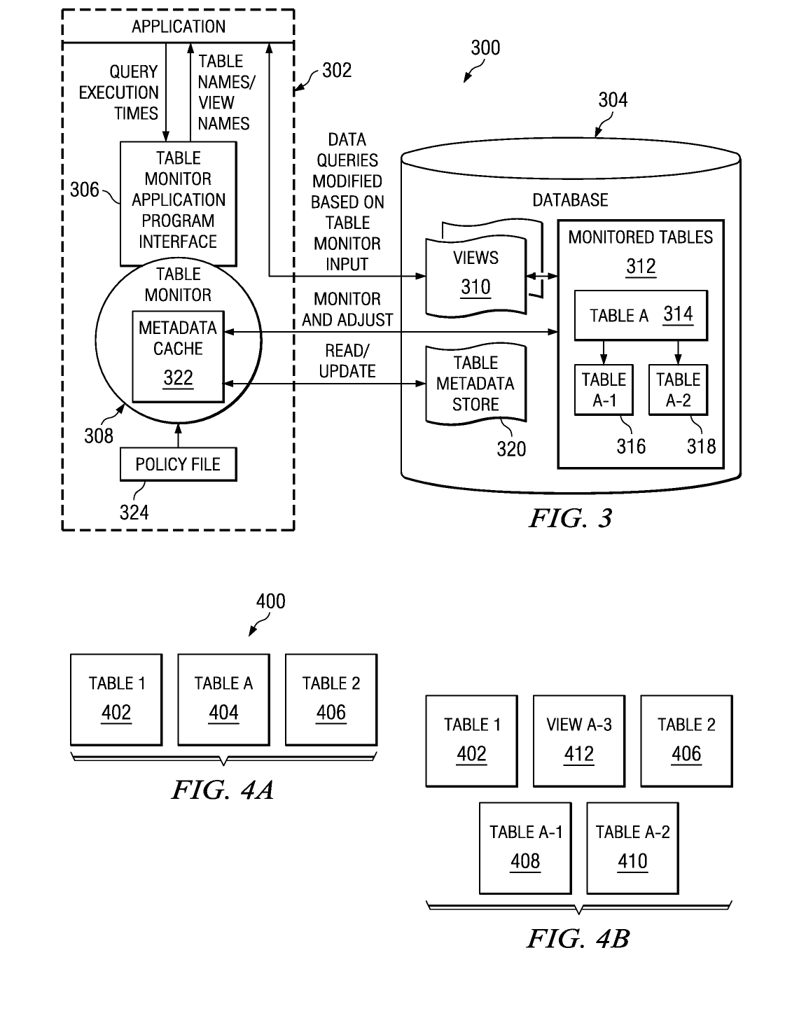

FIG. 3 is a block diagram for a database system in accordance with the illustrative embodiments. Database system 300 includes application 302. Application 302 is a database program application executed on a client or server, such as client 110 or server 104 of FIG. 1. Application 302 may be used to access database 304. Database 304 is a database stored on a client or server, such as client 110 or server 104 of FIG. 1 or in a storage device, such as storage 108 of FIG. 1.

Database 304 is a relational database in this example. A relational database is a database system in which the database is organized and accessed according to the relationships between data items without the need for any consideration of physical orientation and relationships. Relationships between data items in a relational database are expressed by means of a collection of tables logically associated to each other by shared attributes or keys. Any data element may be found in a relational database by knowing the name of the table, the attribute (column) name, and the value of the primary key. In one example, database 304 is a configuration management database (CMDB), which retains a representation of other software and hardware systems internally, among other data.

Application 302 further includes table monitor application program interface 306 and table monitor 308. Table monitor application program interface 306 is an interface that allows application 302, which is written in a high-level language, to use specific data or functions of table monitor 308. Table monitor 308 is a process or component of the configuration management database at the application level used to perform various functions for tuning database 304.

Table monitor 308 analyzes monitored tables to determine when tuning of the database schema is required. Monitored tables 312 includes tables being monitored by table monitor 308. The configuration management database is only an exemplary application database. Any database application, particularly one using a relational database, will have “relationships” or join tables as illustrated by the tables in monitored tables 312. This includes accounting applications, airline reservations, financial applications, etc. Join tables are a fundamental technique used in a relational database design. For example, monitored tables 312 include tables, such as table A 314, table A-1 316, and table A-2 318. In these examples, monitored tables 312 are join tables that define “relationships” such as runson, installedon, and accessedvia to name a few. In other examples, the tables in monitored tables 312 may be any other sort of join table for joining multiple tables. Tables that do not define relationships but instead contain records involved in relationships can also be monitored and tuned by a table monitor especially when data skew exists. The join table may be autonomically tuned as described herein. A view is a database object that is a virtual table or logical table composed of the result set from other tables. The view is not part of the physical schema. The view changes dynamically as the contents of the underlying table change. Table monitor 308 may be used to monitor a single table or may be used to watch a small subset of tables as shown in monitored tables 312. FIG. 3 shows only one table monitor 308, in other illustrative embodiments, application 302 may have multiple table monitors for monitoring different tables simultaneously.

Table monitor 308 analyzes the total number of relationship records as well as the number of each type of relationship record stored in table A 314 within monitored tables 312. A relationship record in a relational database may comprise each row of each table. For example, the relationship record may be for phone numbers. The relationship records may be further used to tune the database or modify a query.

Table monitor 308 analyzes read-SQL statement performance going through the relationship table. The read-SQL statement performance may be stored in table metadata store 320. For example, the read-SQL statement performance may specify how long each read-SQL call takes. Metadata is descriptive data that describes the characteristics of stored data. In one illustrative example, table metadata store 320 may include information such as the name of the table, the name of the database that contains the table, the names of the columns in the table, and the column descriptions, utilizing either technical or business descriptors.

Information monitored or analyzed by table monitor 308 may be stored in metadata cache 322. Metadata cache 322 is a large bank of random access memory designated for temporary storage of frequently accessed data and information.

Table monitor 308 has access to policy file 324. Policy file 324 is a set of rules used to govern application 302. For example, policy file 324 may specify thresholds for actions. Once the threshold is exceeded, table monitor 308 may adjust table A 314 within monitored tables 312 and update table metadata store 320.

The following example further explains how table monitor 308 functions to tune database 304. Consider a relationship table, such as table A 314 including the following relationships:
contains
dependson
usedBy
runsOn

Each of these relationships is used to relate other data records in database 304 as follows:

Record A → contains → record B
Record A → dependsOn → record B
Record C → runsOn → Record D

Table monitor 308 periodically updates in-memory counts of the total number of records as well as the number of contains, dependsOn, runsOn, and usedBy relationships stored in table metadata store 320. As the main thread of execution in a change management database (CMDB), such as database 304, executes queries, the execution time results are passed to table monitor 308. When data skew occurs in the data records in the relationship table, table monitor 308 partitions the data along a specific attribute and moves the appropriate data into separate tables.

When a threshold specified in policy file 324 is reached, table monitor 308 takes action. For example, if table monitor 308 is watching table A 314 in monitored tables 312 and assumes that the “runsON” relationship dominates the relationship types stored in table A 314, table monitor 308 may take various actions.

For example, in response to reaching a threshold, table monitor 308 creates two copies of table A 314 in this example. For example, table A 314 may be split into a table for creating smaller tables with more efficient indexes for increasing the access time and general performance data of queries. Smaller tables have fewer records to look through when trying to find relationships. In various embodiments of the present invention, any number of triggers may cause the data in the table to be split. In some common examples, a table is split based on data skew combined with total record count and access times to the table.

The tables are named similarly to the original table when created, in this example, table A-1 316 and table A-2 318. Next, table monitor 308 partitions the data in table A 314 between the two new tables by copying specific records of data. All dependson and usedBy relationships are placed in table A-1 316 and runsOn relationships are placed in table A-2 318. A “schema definition” table, such as table metadata store 320 is updated to track the fact that table A 314 is now logically comprised of two database tables, table A-1 316 and table A-2 318. Table A 314 may be deleted once database 304 and table monitor 308 have updated information about table A-1 316 and table A-2 318.

Table monitor 308 caches the information in the schema definition table in a cache, such as metadata cache 322. A view is created in views 310 to simulate the original table A 314 that contained all of the relationships in case an original perspective of the data from table A 314 is required. A lock in the data layer of the application, such as table monitor application program interface 306 prevents access during the schema change. The resulting new tables, table A-1 316 and table A-2 318, are smaller and the indexes more efficient. Manual tuning issues, such as dealing with manual data partitioning and materialized query table (MQT) maintenance are greatly reduced. A materialized query table is a physical table which stores the contents of predefined views. Once the MQT is created, the query optimizer automatically redirects queries to the MQT whenever the query can leverage it.

After partitioning, application 302 attempts to access table A 314 in order to follow a relationship. The type of query typically run by application 302 through the relationship table is to request all of the records to be tied to something through a runsOn relationship. The query essentially states: Find all of the software packages that “runOn” computer system A. As application 302 constructs the dynamic structured query language query to retrieve the data, table monitor 308 consults the schema definition in table metadata store 320 to discover that the runsOn relationship is stored in table A-2 318.

Table monitor 308 ensures that table A-2 318 is incorporated into the query, and the appropriate query is executed to find the data. Although the query is built dynamically on the first call, subsequent calls may use the prepared query to improve performance. Prepared queries may be invalidated when table monitor 308 changes the schema.

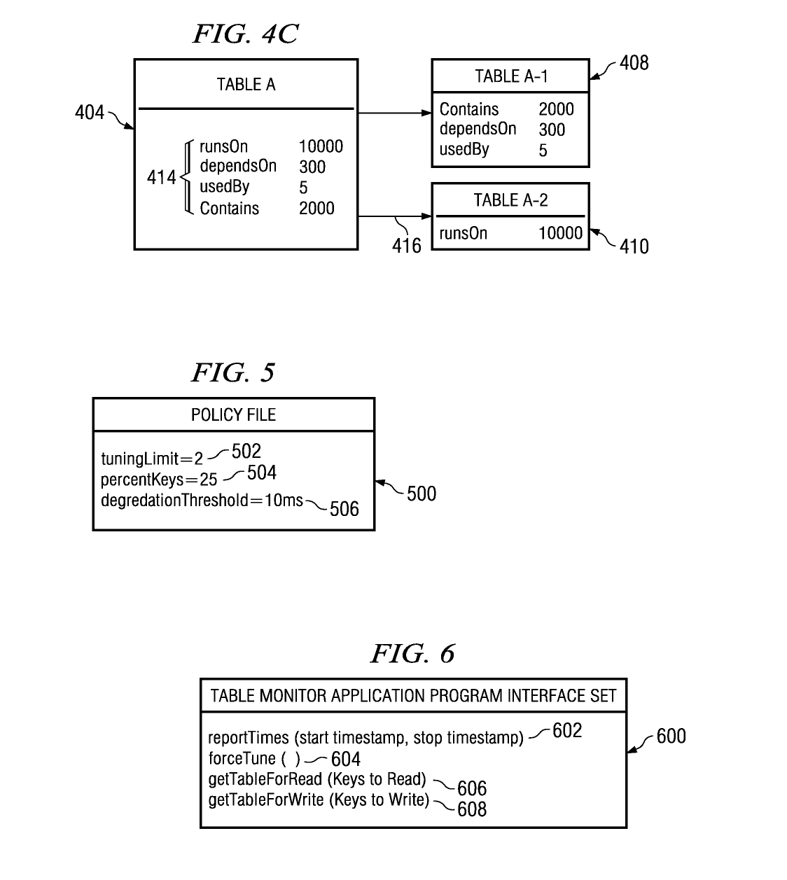

FIG. 4A is a table structure before autonomic tuning in accordance with the illustrative embodiments. Database structure 400 is the structure or database schema of tables within a database and/or monitored tables element, such as database 304 of FIG. 3. Database structure 400 includes table 1 402, table A 404, and table 2 406. The tables are relationship tables, such as table A 314 of FIG. 3.

The application, such as application 302 of FIG. 3, has a database query that works against database structure 400 that looks like the following:
Select all records from table 1 402, table 2 406, and table A 404 where the key column in table A 404=runsOn and the key column in table 2=windows.

FIG. 4B is a database structure after autonomic tuning in accordance with the illustrative embodiments. In FIG. 4B, database structure 400 has been tuned. In this example, the table monitor, such as table monitor 308 of FIG. 3, replaces table A 404 with table A-1 408 and table A-2 410. Additionally, the table monitor creates view A-3 412 that “joins” the two new tables. Data from table A 404 is re-distributed into table A-1 408 and table A-2 410. Data is re-distributed into the new tables based on the key of the original table to minimize the impact of data skew. Once all data is copied, table A 404 may be dropped from the database. Table A-1 408 and table A-2 410 are still joined by relationships.

After database structure 400 has been modified to include new tables, the previously described query is automatically adjusted by the table monitor as follows:
Select all records from table 1 402, table 2 406, view A-3 412 where key column in view A-3 412=runsOn and the key column in table 2 406=windows

Alternately, depending on the amount of data, the query may be automatically adjusted by the table monitor as follows:
Select all records from table 1 402, table 2 406, table A-1 408 where key column in table A-1 408=runsOn and the key column in table 2 406=windows

Write queries or queries that place data into the database are similarly altered. An original insert query against the schema in FIGS. 4A-4B appears as follows:
Insert “runsOn”, parent, child into table A 404;

After database structure 400 is tuned in FIG. 4B, the query is modified by the table monitor as follows:
Insert “runsOn”, parent, child into Join table A-1 408;

The table monitor uses the metadata cache, such as metadata cache 322 of FIG. 3 when constructing the new insert query to determine whether join table A-1 408 or table A-2 410 is the appropriate table to be used in the insert statement. Key values and the tables to which they were redistributed during the redefinition of the database schema, determine which table to use.

FIG. 4C illustrates autonomic tuning in accordance with the illustrative embodiments. FIG. 4C shows one way in which data is split during the schema transformation. Table A 404 includes relationship keys 414 stored in the table along with hypothetical counts of the number of times that the key is used to join the records in table A 404. In this example, the method or algorithm used for reorganization moves the key that appears the most in the relationship table, runsON 416, to table A-2 410 by itself if possible. In other examples, table A-2 410 may be shared with another relationship that occurs frequently. Any relationship in relationship keys 414 that is not selected for the first table is moved into the second table in this example.

FIG. 5 is an exemplary policy file in accordance with the illustrative embodiments. Policy file 500 shows exemplary contents of a policy file, such as policy file 324 of FIG. 3. In this example, tuningLimit 502 specifies the number of times that the table monitor will try to split a relationship table automatically. Splitting the table too much or too often may cause too much complexity in building queries to find data. The administrator of the system may determine the best setting for the tuning limit. The value is an integer value, such as tuningLimit 502 of two.

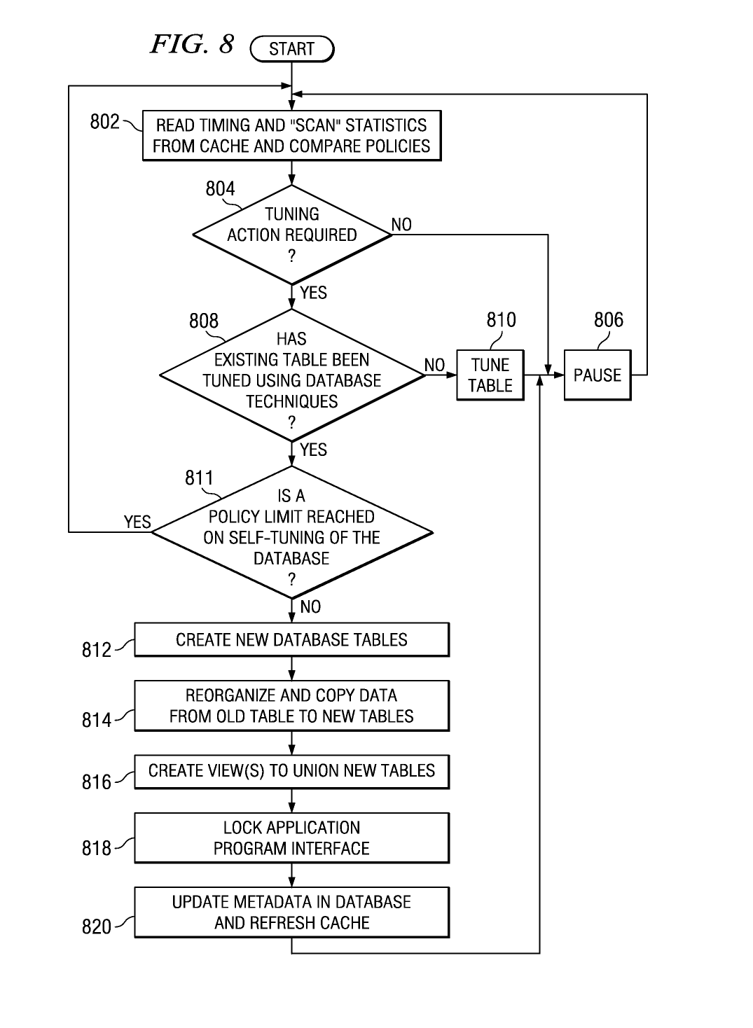

PercentKeys 504 specifies a “data skew” limit to consider when deciding if data should be split between two tables. In the provided example, if one key value in a table reaches 25% of the entries in that table, then the table monitor will take action, such as in process block 804 of FIG. 8.

DegredationThreshold 506 specifies the time in milliseconds in which the performance may degrade before tuning action will be taken based on response time. In the given example, if the initial read queries through a join table take 8 milliseconds, later read queries may take up to 18 milliseconds before the table monitor will take action to tune the table.

FIG. 6 is an exemplary table monitor application program interface set in accordance with the illustrative embodiments. Table monitor application program interface set 600 shows exemplary contents of a table monitor application program interface, such as table monitor application program interface 306 of FIG. 3. ReportTimes 602 is an application program interface used by the application to tell the table monitor how long a read query took to execute. For example, the difference between the start and stop timestamp is calculated to estimate how long the read query on a join table, such as table A 314 of FIG. 3 took. This information is stored and averaged as part of the response time determination.

ForceTune 604 is an application program interface that is called by either the application or a system administrative interface to the application program interface to force “autonomic” tuning to take place even if the thresholds as defined in the policy file are not reached.

TableForRead 606 is an application program interface called by the application when it needs to execute a read query. TableForRead 606 accepts the original table name based on the original schema and returns the actual table names and/or views that should be used based on the actual state of the schema after tuning.

TableForWrite 608 is called by the application when it needs to execute a write query. TableForWrite 608 accepts the original table name based on the original schema and returns the actual table names and/or views that should be used based on the actual state of the schema after tuning.

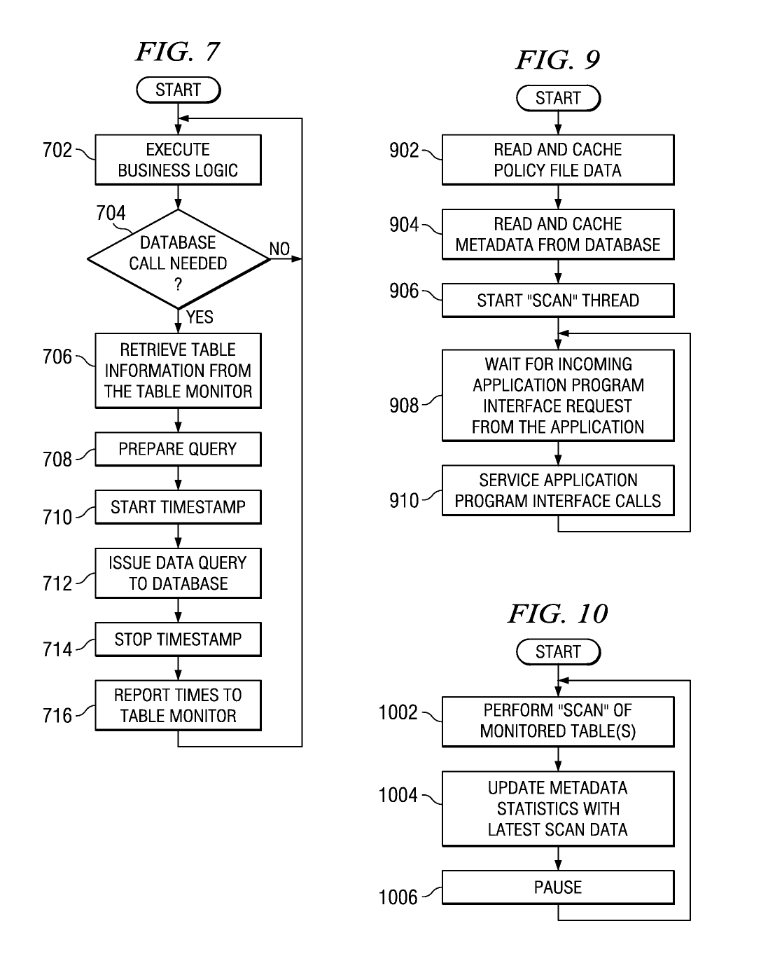

FIG. 7 is a flowchart for an application process using a table monitor in accordance with the illustrative embodiments. The process of FIG. 7 may be implemented by a database application, such as database application 302 of FIG. 3. The process begins by executing business logic (process block 702). Next, the process determines whether a database call is needed (process block 704). Whether the call is needed in process block 704 is based on the application logic. Whenever the application needs to retrieve data from the database to continue processing, then a database call is needed. If the process determines that the database call is not needed, the process returns to process block 702. If the process determines that the database call is needed in process block 704, the process retrieves table information from the table monitor (process block 706). The table monitor may be a table monitor, such as table monitor 308 of FIG. 3. For example, the application is going to call an application program interface, such as tableForRead 606 or tableForWrite 608 of FIG. 6 to get the actual table to be used in the database query before issuing the database query.

The process then prepares a query (process block 708). During process block 708, the query may be cached by the application. Next, the process starts a timestamp (process block 710). A timestamp is the current time of an event that is recorded by the table monitor. The timestamp is used to measure the amount of time required to receive a response to an issued query in the form of performance data.

Next, the process issues the data query to a database (process block 712), such as database 304 of FIG. 3. The process then stops the timestamp (process block 714). The timestamp may be stopped by stopping a timer or by taking a second timestamp to determine the difference between the timestamps. The timestamp may be stopped once a response is received to the query issued in process block 712. Next, the process reports the times to the table monitor (process block 716) with the process returning to process block 702 thereafter. The time is reported in process block 716 using the start and stop times of the timestamp for analysis and statistical purposes. As a result, the table monitor knows performance data which may include minimum, maximum, and average query times.

FIG. 8 is a flowchart for a tuning thread process in a table monitor in accordance with the illustrative embodiments. The process of FIG. 8 may be implemented by a database system, such as database system 300 of FIG. 3. The process begins by reading timing and ‘scan’ statistics from a cache and comparing policies (process block 802). Scan is a database term where every record in a database table, such as table A 314 of FIG. 3 is read. The table monitor may do a scan, or if the relational database product provides metadata, the table monitor may use that information in order to build the “count” of the number of each relationship in the monitored table. The ‘scan’ statistics are the counts of records illustrated in <new> Figure GHI. The timing and ‘scan’ statistics may be cached in a table monitor in a cache, such as table monitor 308 and metadata cache 322 of FIG. 3, respectively.

Next, the process determines whether tuning action is required (process block 804). If the process determines tuning action is not required, the process pauses (process block 806) before returning to process block 802. If the process determines tuning action is required in process block 804, the process determines whether the existing table has been tuned using database techniques (process block 808). The determination of process block 808 is affected not only by the question “Were relational database techniques already used?”, but also by the question “When were relational database techniques last used?” If it has been a while (e.g., longer than a predetermined threshold amount of time) since new indexes were generated for the table, regenerating statistics will be calculated even if this was done before. Only if statistics were recently generated (e.g., within a predetermined threshold amount of time) and few changes to the table were made will the process determine that using database level tuning techniques are not helpful, wherein the process continues to process block 810.

Conventional relational database products typically include application program interfaces or commands that may be run to re-generate indexes and statistics for a table in the relational database engine. In many cases, application level performance may be significantly improved just by running these commands.

If the process determines the existing table has not been tuned using database techniques, the process tunes the table (process block 810) with the process returning to process block 806. The table is tuned autonomically. Autonomic tuning indicates that the table monitor and corresponding application self-manage tables without the necessity of user intervention. The table is tuned in process block 810 by making changes to the schema. In one example, multiple table schemas, such as table A-1 316 and table A-2 318 are created from a single table, such as table A 314 all of FIG. 3, based on access attributes, distributing the data from the one old table into the two new tables, and generating indexes on the two new tables to increase query performance. The data is split into the two new tables based on the primary key of the data although some other heuristic may be used additionally or alternatively. If the process determines the existing table has been tuned using database techniques in process block 808, the process determines whether a policy limit is reached on self-tuning of the database (process block 811). For example, there may be a policy limit, such as tuningLimit 502 of FIG. 5 that specifies the table may only be tuned twice. If the process determines the policy limit is reached on self-tuning of the database, the process returns to process block 802. If the process determines the policy limit has not been reached on self-tuning of the database in process block 811, the process creates new database tables (process block 812). It is important to note that the process of FIG. 8 may be applied to one or more tables. For example, in process block 812, the process may create a single table or multiple new database tables.

Next, the process reorganizes and copies data from the old table to the new tables (process block 814). Then, the process creates view(s) to union the new tables (process block 816). For example, in process block 816, a “create view” command may be issued and a database object called a view is created that shows the data in any number of tables as if the data were still in one table. The view that is created is used for read operations that might span several of the new tables. Next, the process locks the application program interface (process block 818). The application program interface may be a table monitor application program interface, such as table monitor application program interface 306 of FIG. 3. Next, the process updates metadata in the database and refreshes the cache (process block 820) with the process returning to process block 806. The metadata may be stored in a table, such as table metadata store 320 of FIG. 3. The metadata includes information about the data within the database. For example, the metadata is updated in process block 820 so that the database may properly access data that is now stored in the new tables.

FIG. 9 is a flowchart for a main thread initialization process in a table monitor in accordance with the illustrative embodiments. The process of FIG. 9 may be implemented by a database system, such as database system 300 of FIG. 3. The process begins by reading and caching policy file data (process block 902). The policy may be a policy, such as policy file 324 of FIG. 3. The policy file data may be cached in a metadata cache of a table monitor, such as metadata cache 322 of table monitor 308 both of FIG. 3.

Next, the process reads and caches metadata from the database (process block 904). The metadata may be cached in a table monitor metadata cache from a table metadata store, such as table metadata store 320 of FIG. 3. Then, the process starts a ‘scan’ thread (process block 906). As previously mentioned, the table monitor counts the number of each primary key in the monitored table for the heuristic being described. One way of getting the primary key data is to ‘scan’ the table, (e.g., to look at each record in a database table and count the number of times a particular primary key is found). This activity is called a table scan in database terms. Often, table scans are not very efficient so a separate thread is used in one embodiment to perform this activity. If the relational database product keeps these counts where the counts may be accessed via an application program interface, the application program interface may be used rather than perform a table scan.

Next, the process waits for an incoming application program interface request from the application (process block 908), such as table monitor application program interface 306 and application 302 of FIG. 3. Next, the process services the application program interface calls (process block 910) before returning to process block 908. In the described embodiment, “servicing” an application program interface call or request entails performing an operation that the caller of the application program interface requested. For example, if the application calls the “reportTimes” application program interface, the application expects the table monitor to save those times, calculate average times, and otherwise do whatever the reportTimes application program interface is meant to do, and then return to the application.

FIG. 10 is a flowchart for a scan thread flow in a table monitor in accordance with the illustrative embodiments. The process of FIG. 10 may be implemented by a table monitor, such as table monitor 308 of FIG. 3. The process is a more detailed description of process block 906 of FIG. 9. The process begins by performing a ‘scan’ of the monitored tables (process block 1002). Next, the process updates metadata statistics with the latest scanned data (process block 1004). Then, the process pauses (process block 1006) before returning to process block 1002.

Thus, the illustrative embodiments provide a computer implemented method, apparatus, and computer usable program code for autonomic tuning of a database schema. The illustrative embodiments provide a table monitor within the application used to analyze performance data and data skew in the database tables. The database application itself is used to automatically tune the database schema and queries used by the application. The table monitor uses database application-specific knowledge to tune performance so that tuning is truly autonomic. As a result, a user or database administrator is not required to adjust a database engine, saving time and effort and thus providing better database performance.

Embodiments of the present invention may be implemented entirely in hardware, entirely in software or using a combination of both hardware and software elements. In one embodiment, the invention is implemented in software, including but not being limited to firmware, resident software, microcode, or the like.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a communication medium (e.g., a system bus). The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention embodiments in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for managing a database, the computer implemented method comprising:
determining performance data for the database, wherein the performance data relies on a key of the database;
responsive to determining the performance data, autonomically modifying a schema of the database utilizing the performance data.

2. The computer implemented method of claim 1, wherein the determining further comprises:
monitoring the performance data based on a prior access to the database; and
analyzing a number of relationship records.

3. The computer implemented method of claim 1, wherein the determining further comprises:
timing query execution.

4. The computer implemented method of claim 3, wherein the timing is performed using timestamps.

5. The computer implemented method of claim 1, wherein a table monitor performs the determining and the determining further comprises:
monitoring query execution using timing statistics and scan statistics.

6. The computer implemented method of claim 1, wherein the autonomically modifying further comprises:
creating new tables from an original table based on the key for increasing query performance.

7. The computer implemented method of claim 6, wherein the autonomically modifying further comprises:
creating a view to union the new tables for display to a user.

8. The computer implemented method of claim 6, wherein the new tables include relationship keys of the original table, wherein one of the new tables includes primary keys and another of the new tables includes secondary keys.

9. The computer implemented method of claim 5, further comprising:
updating a cache of the table monitor with the performance data and relationship records.

10. The computer implemented method of claim 1, wherein the determining and autonomically modifying are performed by a database application.

11. The computer implemented method of claim 1, wherein the autonomically modifying is performed in response to locking an application program interface for the database application.

12. The computer implemented method of claim 1, further comprising:
updating database metadata to record an autonomic modification of the schema of the database.

13. A data processing system comprising:
a bus system;
a communications system connected to the bus system;
a memory connected to the bus system, wherein the memory includes a database and database application; and
a processing unit connected to the bus system, wherein the processing unit may be loaded into a main memory for execution by the processing unit, wherein the processing unit executes the database application and a table monitor within the database application, wherein the table monitor determines performance data for the database, wherein the performance data indicates an key of the database, and modifies a schema of the database autonomically utilizing the performance data.

14. The system of claim 13, further comprising a table monitor cache for storing the performance data and the relationship records.

15. The system of claim 13, wherein the table monitor communicates with the database application through locking an application program interface.

16. The system of claim 15, wherein the application program interface is locked to update the database metadata.

17. A computer program product comprising a computer usable medium including computer usable program code for managing a database, the computer program product comprising:
computer usable program code for generating performance data about a database; and
computer usable program code, responsive to receiving negative performance data, for autonomically modifying a schema of the database utilizing the performance data.

18. The computer program product of claim 17, wherein the computer usable program code for autonomically modifying further comprises:
computer usable program code for creating new tables and new views in the database.

19. The computer program product of claim 17, further comprising:
computer usable program code for altering database query definitions based on the new tables or the new views.

20. A database system comprising:
a database application for managing a database, wherein the database includes a table monitor, wherein the database application generates performance statistics for a plurality of tables within the database; and
a database operably-connected to the database application, wherein the plurality of tables and a plurality of views are stored in the database;
wherein the table monitor autonomically tunes the database utilizing the performance statistics by creating a plurality of new tables from a table within the plurality of tables, wherein the plurality of new tables are created by dividing relationships in the table between the new tables for increasing query performance of the database, and wherein the table monitor creates a view to union the plurality of new tables for queries of the table.
